(19) United States
(12) Patent Application Publication
(10) Pub. No.: US 2014/0176562 A1
(43) Pub. Date: Jun. 26, 2014

(54) SYSTEMS AND METHODS FOR PROVIDING A SOFTWARE APPLICATION PRIVACY SCREEN

(71) Applicant: APPSENSE LIMITED, Warrington (GB)

(72) Inventor: Richard James SOMERFIELD, San Jose, CA (US)

(73) Assignee: APPSENSE LIMITED, Warrington (GB)

(21) Appl. No.: 13/724,551

(22) Filed: Dec. 21, 2012

(51) Int. Cl. G06T 11/20

(52) U.S. Cl. CPC G06T 11/203
USPC 345/443

(57) ABSTRACT

Systems and methods are provided for applying a localized software privacy screen over the display of specific applications, files, and/or other content on a computing device. In response to a user request, a computing device can open a window comprising a file or content in an associated application on its output display, determine whether a privacy screen should be applied to the user interface, and apply the privacy screen in a visual layer over the user interface if specified by the settings, rules, and/or permissions. The privacy screen can be user modifiable and can be made up of plurality of privacy lines that may be of any suitable orientation, thickness, spacing, and/or color and opaqueness that permits the user of the computing device to view the underlying window while preventing unauthorized onlookers from viewing the same.

### BACKGROUND

1. Technical Field

Disclosed systems and methods relate to the application of a software privacy screen to applications, files, and/or other content displayed on a computing device to reduce the exposure of sensitive application data to unauthorized individuals.

2. Description of the Related Art

Today, the increased use of telecommuting and remote working environments has created new security challenges. As workers take laptops, tablets, and mobile devices outside of the workplace, confidential and sensitive information is becoming increasingly available outside of a secure working environment. The popularity of working in coffee shops, bus or train stations, airports, on buses, trains or airplanes, and other public places has increased the potential risk of exposure of confidential and sensitive information to onlookers and occasional passersby.

Today, physical privacy screens are typically used to protect sensitive onscreen information from unsecured, unintended onlookers. To use these screens, users must physically attach privacy screen filters over their output displays. The filters are often framed by rigid or semi-rigid frames to firmly align the screen material over the output display. These filters usually employ optical polarization techniques, which help limit light output from the screen to a narrow angle in front of the display. The limited dispersing of light renders onscreen data visible only to persons directly in front of the screen.

These filters, however, carry several disadvantages. They are often cumbersome and require attaching an external plastic or metal frame to the display screen. This problem mostly affects users on the go, who often desire fewer and more portable accessories and equipment. These filters also have a tendency to dramatically darken the screen, rendering it difficult to view both sensitive and non-sensitive information. The polarization techniques in many of these screens typically also reduce the transparency of the screen. The darkening effect particularly affects users under sunlight, where LCD and LED screens are hardest to view under normal conditions. Relatedly, these filters are also non-localized and cover the entire screen. Accordingly, the filter dims the entire screen, including portions containing non-sensitive, non-confidential information.

Therefore, there is a need to provide more convenient systems and methods for providing a privacy screen in software. Accordingly, it is desirable to provide systems and methods that overcome these and other deficiencies of the related art.

### SUMMARY

In accordance with the disclosed subject matter, systems and methods are provided for applying a localized software privacy screen over applications and/or files containing sensitive and confidential information displayed on a computing device.

The disclosed subject matter includes a method. The method can include receiving a request to open a file or content on a computing device; in response to the request, generating and displaying a window comprising the file or content in an associated application on an output display associated with the computing device; determining whether a privacy screen should be applied to the window; and applying the privacy screen in a visual layer over the window if the privacy screen should be applied, wherein the privacy screen is comprised of a plurality of privacy lines configured to allow a user of the computing device to view contents of the window and to prevent an unauthorized onlooker from viewing the contents of the window.

The disclosed subject matter also includes an apparatus comprising a processor configured to run a module stored in memory. The module can be configured to receive a request to open a file or content on a computing device; in response to the request, generate and display a window comprising the file or content in an associated application on an output display associated with the computing device; determine whether a privacy screen should be applied to the window; and apply the privacy screen in a visual layer over the window if the privacy screen should be applied, wherein the privacy screen is comprised of a plurality of privacy lines configured to allow a user of the computing device to view contents of the window and to prevent an unauthorized onlooker from viewing the contents of the window.

The disclosed subject matter further includes a non-transitory computer readable medium having executable instructions. The executable instructions are operable to cause an apparatus to receive a request to open a file or content on a computing device; in response to the request, generate and display a window comprising the file or content in an associated application on an output display associated with the computing device; determine whether a privacy screen should be applied to the window; and apply the privacy screen in a visual layer over the window if the privacy screen should be applied, wherein the privacy screen is comprised of a plurality of privacy lines configured to allow a user of the computing device to view contents of the window and to prevent an unauthorized onlooker from viewing the contents of the window.

In one aspect, the method, the apparatus, or the non-transitory computer readable medium can further include steps, modules, or executable instructions for determining the application associated with the requested file or content. In one aspect, the method, the apparatus, or the non-transitory computer readable medium can further include steps, modules, or executable instructions for determining whether the privacy screen applies to one of the application and the file or content. If the privacy screen applies to the application, the steps, modules, or executable instructions apply the privacy screen to the window for the file or content and any other file or content opened in the application. If the privacy screen applies to the file or content, the steps, modules, or executable instructions apply the privacy screen to the window for the file or content and separately determine whether the privacy screen applies to any other file or content opened in the application.

In one aspect, the method, the apparatus, or the non-transitory computer readable medium can include steps, modules, or executable instructions performing one of checking a stored privacy setting indicating whether to apply the privacy screen to the application; and receiving a request to apply the privacy screen to the application. In one aspect, the method, the apparatus, or the non-transitory computer readable medium can include steps, modules, or executable instructions for determining whether the output display is physically located external to a secure office environment; and applying the privacy screen to the window if the computing device is physically located external to the secure office environment.

In one aspect of the method, the apparatus, or the non-transitory computer readable medium, the plurality of privacy lines comprises at least one of a plurality of lines having a predefined orientation, thickness of the lines, spacing between the lines, distance to the window, color, and transparency.

In one aspect of the method, the apparatus, or the non-transitory computer readable medium, the plurality of privacy lines is user-configurable.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked system in accordance with an embodiment of the disclosed subject matter.

FIG. 2 illustrates a block diagram of a computing device in accordance with certain embodiments of the disclosed subject matter.

FIG. 3 is a flow diagram illustrating a process for displaying a software privacy screen in accordance with certain embodiments of the disclosed subject matter.

FIG. 4 illustrates the implementation of a visual layer in accordance with an embodiment of the disclosed subject matter.

FIGS. 5A-5B illustrates the implementation of a software privacy screen over a window comprising a file or content in an associated application in accordance with an embodiment of the disclosed subject matter.

FIG. 6 illustrates the implementation of a software privacy screen over a window comprising a file or content in an associated application in accordance with an embodiment of the disclosed subject matter.

FIG. 7 illustrates the implementation of a software privacy screen over a window comprising a file or content in an associated application in accordance with an embodiment of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

The disclosed subject matter is aimed at correcting a problem in the prior art where sensitive information may be visible to unsecured onlookers. The current practice of using non-localized, general privacy screens is cumbersome, reduces visibility of the screen, and obscures both sensitive and non-sensitive information.

Accordingly, the systems and methods in the present disclosure address those problems by using a software-based, rather than a hardware, privacy screen to reduce the exposure of sensitive application data to unauthorized individuals. The software privacy screen may comprise privacy lines of various widths, spacing, color, transparency, and orientation. These privacy lines may be implemented in a visual layer overlaying the user interface below. In some embodiments, the privacy screen may be invoked either by the type of application, the file or content, or other settings, rules and/or permissions. For the files, it can be all files, all files of a particular type, all files opened by a particular application, all files from a particular source (storage location, folder), all files that have been password protected, all files that have certain metadata information, all files authored or accessed by a particular user, files selected by a user and/or corporation, etc. For content, it can be forms of a particular type of content, such as web pages or streaming video.

There can be a user interface in a separate software privacy screen application or as part of each application that allows a user and/or corporation to select the settings/rules/permissions for when the software privacy screen is to be applied or not applied. The user and/or corporation can modify and/or be prevented from modifying the settings/rules/permissions. The settings/rules/permissions can be set in advance or in real-time as a user accesses or works in certain applications and/or files.

In one embodiment, the software privacy screen can act like a physical screen and can cover the entire output display. In other embodiments, the privacy screen may selectively cover the user's output display while leaving the rest of the output display unaffected. For example, the privacy screen can cover the entire window of an application or file or content or it can cover any suitable portion of the window of an application or file. As a user changes the window size of an application or file or content the software privacy screen can change accordingly.

Alternatively, the user can independently move and/or change the window size of the software privacy screen to cover any desired portion of the output display. If a corporation has applied certain settings/rules/permission to a particular application and/or file, the user can be prevented from moving and/or changing the window size of the software privacy screen in a way that no longer covers the application and/or file or content window. In still other embodiments, the privacy screen may comprise of user-modifiable privacy lines separated by user-modifiable spaces.

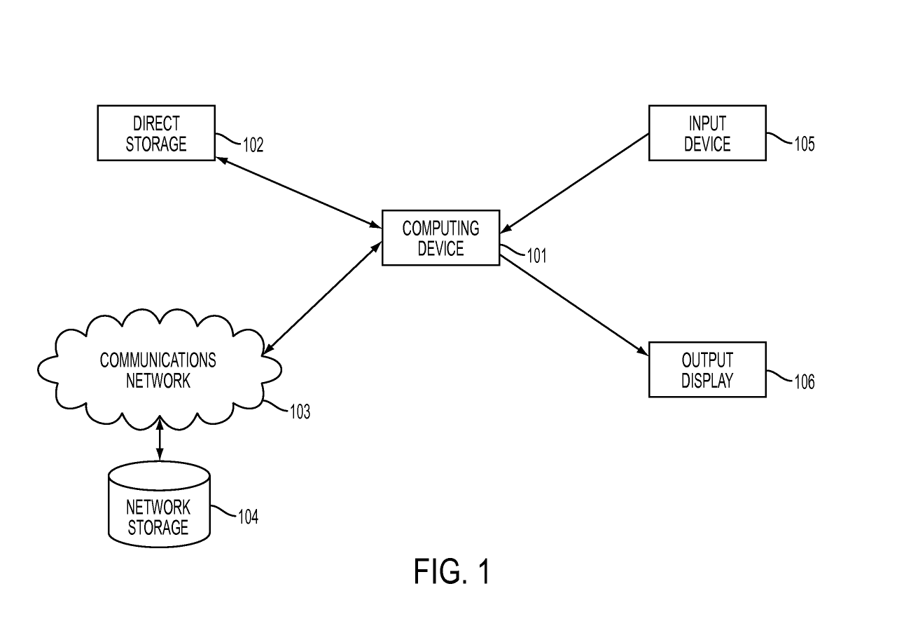

FIG. 1 illustrates a diagram of a networked electronic system in accordance with an embodiment of the disclosed subject matter. The networked system 100 can include a computing device 101, direct storage 102, communications network 103, network storage 104, input device 105, and output display 106.

The computing device 101 can include a desktop computer, a mobile computer, a tablet computer, a cellular device such as a smartphone, or any computing system that is capable of performing computation. The computing device 101 can send data to, and receive data from, direct storage 102 and network storage 104 via communications network 103. Although not shown, computing device 101 can also include its own local storage medium. The local storage medium can be a local magnetic hard disk or solid state flash drive within the device. Alternatively or in addition, the local storage medium can be a portal storage device, such as a USB-enabled or Firewire-enabled flash drive or magnetic disk drive. As shown in FIG. 1, computing device 101 can receive input signals from the input device 105 as well as send display data to output display 106.

In addition to local storage within computing device 101, each computing device 101 can be directly coupled to the external direct storage 102 using direct cable interfaces such as USB, eSATA, Firewire, Thunderbolt interfaces. Alternatively, each client 101 can be connected to cloud storage in communications network 103 via any other suitable device, communication network, or combination thereof. For example, each client 101 can be coupled to the communications network 103 via one or more routers, switches, access points, and/or communication networks (as described below in connection with communications network 103).

The communications network 103 can include the Internet, a cellular network, a telephone network, a computer network, a packet switching network, a line switching network, a local area network (LAN), a wide area network (WAN), a global area network, or any number of private networks that can be referred to as an Intranet.

The communications network 103 can also be coupled to a network storage 104. The network storage 104 can include a local network storage and/or a remote network storage. Local network storage and remote network storage can include at least one physical, non-transitory storage medium. Such networks may be implemented with any number of hardware and software components, transmission media and network protocols. FIG. 1 shows the communications network 103 as a single network; however, the communications network 103 can include multiple interconnected networks listed above.

The input device 105 can be configured as a combination of circuitry and/or software capable of receiving an input signal. In some embodiments, the input device 105 can be configured as a touchscreen and controller chip in combination with specific driver software. In such embodiments, the input device 105 can be configured to sense inputs on a touchscreen from a stylus or one or more fingertips. In other embodiments, the input device 105 can be configured to sense inputs from a mouse, trackball, touchpad, track pad, control stick, keyboard, or other input device.

The output display 106 can be an external monitor, such as a desktop monitor or terminal screen. Alternatively, the output display 106 can be integrated into the computing device 101. When integrated into the computing device 101, the output display 106 can be a liquid crystal display (LCD), light emitting diode (LED) display, or even a display comprising cathode ray tubes (CRT).

Although computing device 101, input device 105, and output display 106 are shown in FIG. 1 as separate components, all of these components, or any combination thereof, can be integrated into a single device. For example, a tablet computer and smartphone can have the computing device 101 (tablet or phone), input device 105 (touchscreen sensors) and output display 106 (touchscreen display) integrated into a single device.

The disclosed embodiment may involve retrieval by the computing device 101 of a wide variety of file types from direct storage 102, cloud communication network 103, and network storage 104 and/or local storage medium on computing device 101. Such file types can include, for example, TXT, RTF, DOC, DOCX, XLS, XLSX, PPT, PPTX, PDF, MPG, MPEG, WMV, ASF, WAV, MP3, MP4, JPEG, TIF, MSG, or any other suitable file type or combination of file types. These files can be stored in any suitable location within direct storage 102, cloud communication network 103, and network storage 104 and/or local storage medium on computing device 101. Additionally, the disclosed embodiment may involve retrieval of content, such as web pages and streaming video from the Internet.

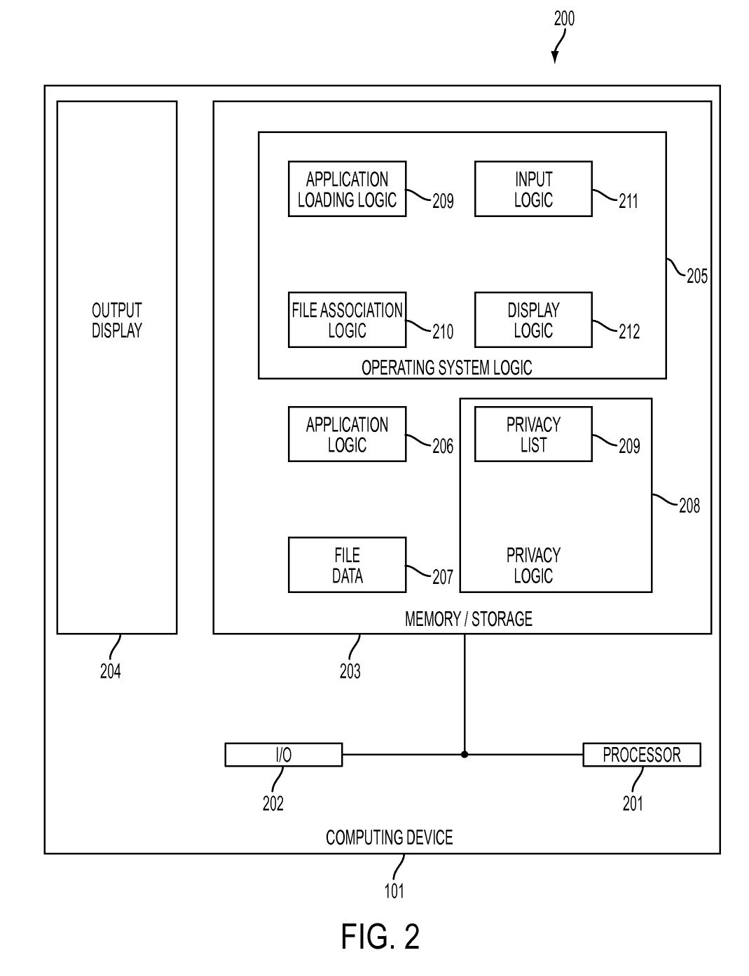

FIG. 2 illustrates a block diagram of a computing device in accordance with certain embodiments of the disclosed subject matter. Specifically, the block diagram 200 shows the computing device 101 having a processor 201, an input/output (I/O) module 202, a memory and/or storage module 203. Memory/storage module 203 includes modules for operating system logic 205, application (specific) logic 206, file data 207, privacy logic 208. Memory/storage module 203 can include any other suitable module or combination of modules.

Processor 201 can be configured as a central processing unit or application processing unit in computing device 101. Processor 201 can also be implemented in hardware using an application specific integrated circuit (ASIC), programmable logic array (PLA), field programmable gate array (FPGA), or any other integrated circuit.

Input/Output controller 202 can include a specialized combination of circuitry (such as ports, interfaces, wireless antennas) and software (such as drivers) capable of handling the reception of data and the sending of data to direct storage 102 and/or network storage 104 via communications network 103.

In addition to handling communications between the computing device 101 and storage units 102 and 104, communications network 103, Input/Output controller 202 can also receive input signals from the input device 105 and send display signals to output display 106. Accordingly, in some embodiments, the Input/Output controller 202 can be configured to interface with specialized hardware capable of sensing inputs on a touchscreen from a stylus or one or more fingertips. In other embodiments, Input/Output controller 202 can be configured to interface with input device 105, which may be specialized hardware capable of sensing inputs from an input device, such as, for example, a mouse, trackball, touchpad, track pad, control stick, and keyboard.

Memory/storage module 203 can be cache memory, non-transitory computer readable medium, flash memory, a magnetic disk drive, an optical drive, a programmable read-only memory (PROM), a read-only memory (ROM), or any other memory or combination of memories.

Memory/storage module 203 includes several logic modules. The operating system logic module 205 can be configured as a specialized combination of software capable of handling standard operations of the device, including allocating memory, coordinating system calls, managing interrupts, local file management, and input/output handling. The operation system logic module 205 can include application loading logic 209, file association logic 210, input logic 211, and display logic 212.

The application loading logic 209 can be configured to determine the memory necessary for the application, allocate the memory for the application, and load application logic 206 into memory in order to open the application user interface on output display 106. When an application is closed, the application loading logic 209 can also be configured to de-allocate and free up the memory that was previously occupied by application logic 206.

The file association logic 210 can be configured to determine the associated application to open if a user selects to open a file, rather than an application. For example, the file association logic 210 can be configured to determine the application associated with the requested file using a lookup table. Once the requested application has been identified, the application loading logic 209 can be configured to load application logic 206 into memory/storage module 203.

Input logic 211 can be configured to interpret signals from the Input/Output controller 202 and input device 105, and to translate those signals into directional inputs and selections from a user. For example, input logic 211 can be configured to interpret signals originating from input device 105, which can be a touchscreen with specific driver software in some embodiments. In those embodiments, input logic 211 can be configured to interpret inputs on a touchscreen from a stylus or one or more fingertips. In some embodiments, input logic 211 can be configured to sense inputs, where the input device 105 is a mouse, trackball, touchpad, track pad, control stick, keyboard, or other input device.

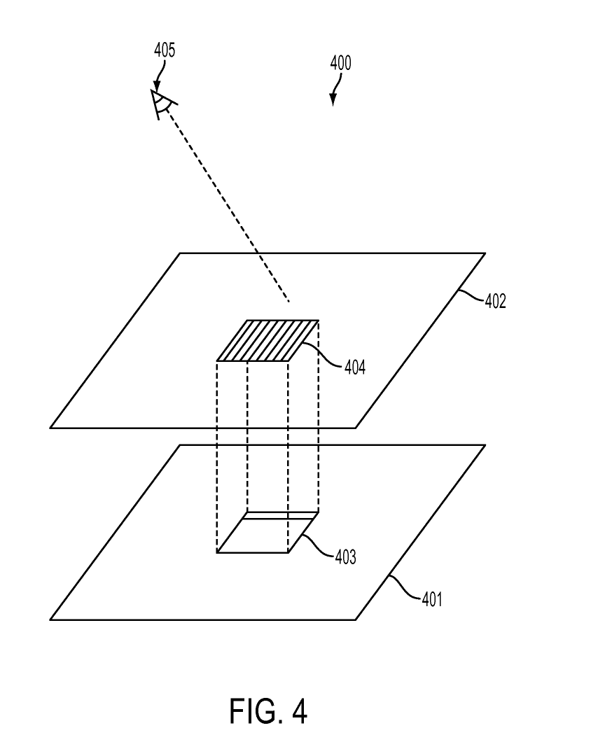

The display logic 212 can be configured to manage visual elements on the output display, including the icons, windows, object layers, and visual effects. The display logic 212 can also manage a visual layer above the user interface in order to implement the privacy screen as shown in FIG. 4. In certain embodiments, this visual layer may be opaque, transparent, or semi-transparent depending on the user's preference.

The application (specific) logic module 206 can be configured to manage application-specific operations that are unique to the operation of the specific application being operated by the user, such as creating application save files, opening application save files, editing application save files, and displaying graphics. Upon receiving a request to open the application, the application loading logic 209 can determine the memory necessary for the application, allocate the memory for the application, and load the appropriate application (specific) logic module 206 into memory/storage module 203. Once loaded into memory/storage module 203, processor 201 may execute the appropriate application (specific) logic 206 in order to operate the application.

The privacy logic module 208 can be configured to determine and manage the appropriate privacy screen over the user interface. In one embodiment, the privacy logic 208 can include predefined, preset default settings based on the window size of the application or file, screen resolution of output display 106, and device type of computing device 101. These default settings may be set by the application, administrator, or the individual user. In one embodiment, the privacy logic 208 may be controlled, edited, and managed by an onscreen application that determines the privacy settings. In one embodiment, this application may have limited access permissions, such that only an administrator may access or edit the settings of the privacy screen. In one embodiment, the privacy settings may be set in real-time.

The privacy settings configurable by privacy logic 208 can be organized into two groups. First, the privacy settings may determine whether a privacy screen even needs to be implemented over the user interface. Depending on whether the operating system logic module 205 receives a user request to open an application or a file in an application, the privacy logic module 208 can be configured to refer to the privacy list 213 to determine whether the application or file necessitates a privacy screen. In some embodiments, the privacy list 213 can be configured as a lookup table organized around applications, file names, and/or settings/rules/permissions set as a default or by a user and/or corporation. In some embodiments, the privacy settings configured by privacy logic 208 may be set to cover a fixed, discrete portion of the output display 106. In some embodiments, the privacy logic 208, alone and/or in combination with data from the Input/Output controller 202, can determine the location of the computing device 101 and/or output display 106. For example, privacy logic 208 can determine whether the computing device 101 (and thus output display 204) and/or output display 106 is physically located external to a secure office environment. If the privacy logic 208 detects that the computing device 101 and/or output display 106 is located external the confines of a secure office environment, the privacy logic 207 can apply a privacy screen over the user interface.

Secondly, the display settings for the overall look and feel of the privacy lines may have default settings or may also be user modifiable. For example, the privacy lines may be horizontal, vertical, or diagonal, or any other orientation or combination thereof. Additionally, the privacy lines may be wide or narrow, or any other suitable thickness or combination thereof. The privacy lines may also be of uniform thickness, varying thickness, or a combination thereof. The spacing of the privacy lines may also be user modifiable, either spaced far apart, closely together, or a combination thereof. Additionally, the privacy lines may be of any suitable variation of gray, black, or any other suitable color. The privacy lines can be of the same color, different colors, different variations of the same color, or any combination thereof. The privacy lines can be opaque, transparent, or a combination thereof Grate patterns and colors can be applied consistently across all applications/files, consistently for particular applications/files, or randomly. Ultimately, the customizability of the privacy lines adjusts the orientation, thickness, spacing, color, and/or transparency of the privacy lines in a way that allows the user to view and work with the application and/or file, while at the same time preventing unauthorized onlookers from seeing the application, file, or other data behind the privacy screen. All of those custom options are stored, managed, and controlled through the privacy logic 208.

In some embodiments, having determined the areas with and/or without a privacy screen, the privacy logic module 208 can be configured to operate in combination with the display logic module 212 to identify which portions of the visual layer (i.e., pixel coverage) above the user interface of the output display require the privacy screen. In some embodiments, by transposing the visual layer with the privacy screens over the user interface, the display logic 212 can be configured to determine an output for the output display 106.

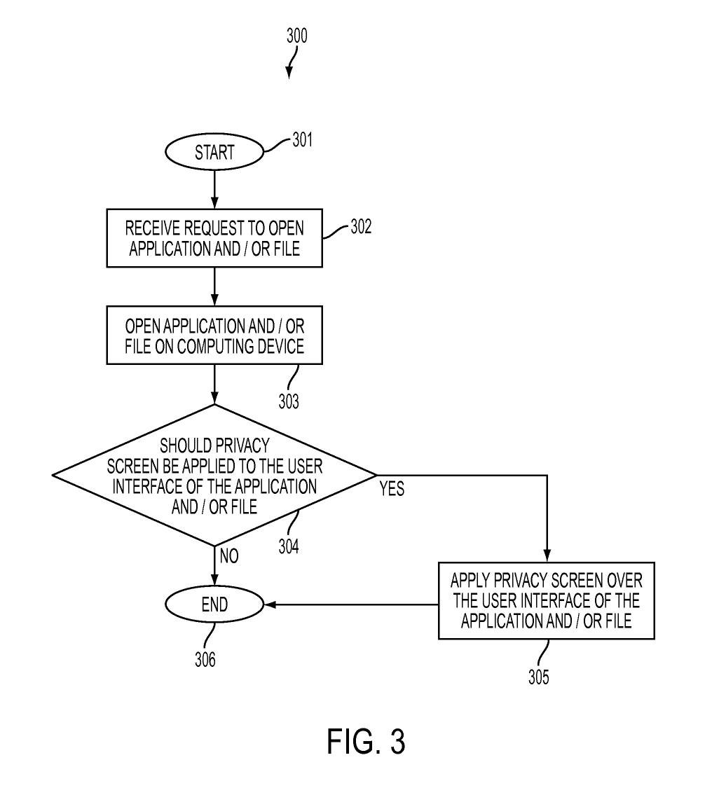

FIG. 3 is a flow diagram illustrating a process 300 for displaying a software privacy screen in accordance with certain embodiments of the disclosed subject matter. Process 300 primarily takes place in the computing device 101 as described above in connection with FIGS. 1 and 2. In step 301, the client 106 can be configured to be ready for the opening of a user interface of an application and/or file or content in an application in output display 106 from FIG. 1.

In step 302, the computing device 101 (FIGS. 1 and 2) can be configured to receive an input from the input device 105 (FIG. 1). As discussed earlier, the input device 105 can be configured as a controller chip and touchscreen, mouse, trackball, touchpad, track pad, control stick, or keyboard. In order to process the input signal from the input device 105, the Input/Output controller 202 can be configured to receive the input signal. Using the signal received by the Input/Output controller 202 and the instructions from the input logic module 211 (within the operating system logic 205 of the memory/storage module 203), the processor 201 can be configured to interpret the input signal as a request. In some embodiments, that request may be evaluated as either a request to open an application or a file or content in an application (that may already be open or not yet open) using the operation system logic 205. In some embodiments, if it is determined that a file was requested, the file association logic 210 can be configured to determine which application is required to be opened.

In step 303, the application loading logic module 209 can allocate memory for the application requested. In some embodiments, this application can be identified by the file association logic 210. Once memory has been allocated, the application loading logic module 209 can load the application logic module 206 into the memory/storage module 203. In some embodiments, if the request is for a file, the application loading logic 209 will also load the file data 207 into the memory/storage module 203.

Once application logic module 206 has been loaded into the memory, the processor 201 can be configured to generate the user interface on output display 106 using the application logic module 206 and display logic 212. Application logic module 206 can be configured to determine which visual elements comprise the user interface and window for the application and/or file while the display logic 212 renders those elements. The video data is ultimately transmitted to the output display 106 using the Input/Output controller 202.

In step 304, the processor 201 can be configured to determine whether a privacy screen should be applied to the user interface for the application and/or file. To do this, the processor 201 can be configured to operate the privacy logic 208. Using the privacy list 213, the privacy logic 208 can be configured to check whether the newly-opened window comprising application and/or file requires a privacy screen. In some embodiments, the privacy list 213 can be configured to additionally list files or content requiring a privacy screen if a file or content is requested to be opened. In some embodiments, the privacy logic 208 can be configured to determine whether a privacy screen should be applied based on the output display 106 or output display 204 on the computing device 101 is physically located external to a secure office environment. When inside the confines of a secure office environment, the privacy settings may be disabled. Alternatively, when external to the secure office environment, the privacy settings may be enabled.

In step 305, using the privacy logic 208 and privacy list 213, the processor 201 has determined that the privacy screen should be applied to the user interface for the application and/or file. In order to apply the privacy screen, the privacy logic 208 can be configured to determine the specific attributes of the privacy screen.

In some embodiments, the privacy screen comprises a plurality of privacy lines in the visual layer over the user interface for the application. The appearance and arrangement of those privacy lines create the privacy requested by the user. Depending on the orientation, thickness of the lines, spacing between the lines, distance to the application or file or content window, color, and/or transparency, the contents of the application or file or content window can be made more or less visible. For example, when viewed from afar or at an angle from the output display, narrow privacy lines with narrow spacing may render text unreadable. In contrast, those same privacy lines may be non-intrusive to a viewer at a closer viewing distance, particularly if the privacy lines are configured to be partially transparent. Similarly, the use of horizontal privacy lines greatly reduces the legibility of text. By comparison, text may be more easily read using vertical privacy lines.

As discussed earlier, the privacy logic 208 stores, manages, and controls customizability options for the privacy lines in order to allow the user to view and work with the application and/or file, while at the same time preventing unauthorized onlookers from seeing the application, file, or other data behind the privacy screen. As discussed earlier, this may involve adjusting the orientation, thickness, spacing, distance, color, and transparency of the privacy lines in various ways.

Once the attributes of the privacy screen have been determined by the privacy logic 208, the display logic 212 can be configured to render the privacy screen in a visual layer above the user interface for the application. As shown in FIG. 4, a privacy screen 404 can be implemented in a visual layer 402 that is configured to be overlaid in software above the user interface of the application 403. The layer 402 is positioned above the operating system user interface 401. From the perspective of a user 405 viewing the output display 400 as a whole, the privacy lines appear to completely overlay the user interface of the application 403. Accordingly, to maintain the illusion of a flat interface, some embodiments are configured to apply transparent visual layers that do not affect data not located behind the privacy screen. Relatedly, if the user interface of the application 403 is repositioned, the display logic 212 (FIG. 2) can be configured to adjust the privacy screen 404 in the visual layer 402 accordingly.

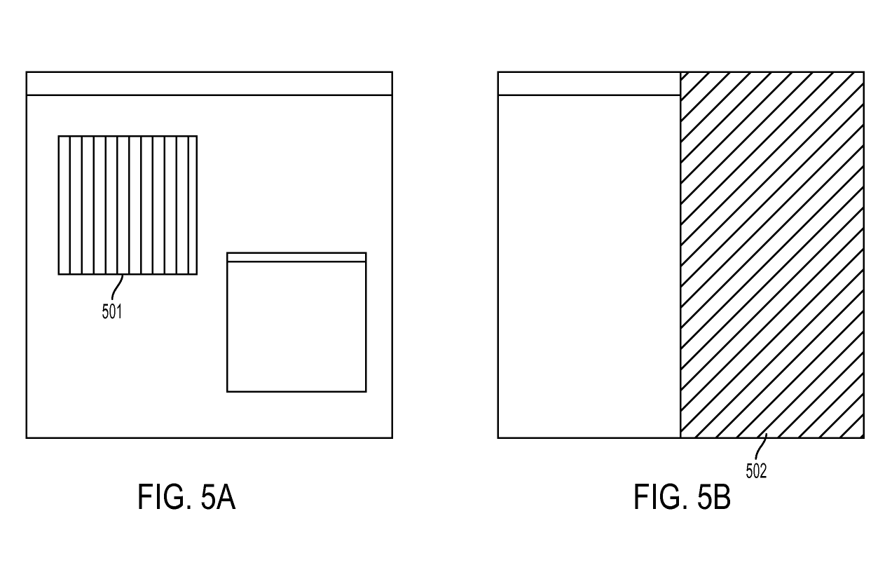

FIG. 5 illustrates the implementation of a privacy screen over a user interface of a specific application (FIG. 5A) and a privacy screen over a fixed portion of the output display 106 (FIG. 5B). In FIG. 5A, from a user's perspective, the privacy lines may only overlay data in a user interface of a single application using vertical lines (501 in FIG. 5A) while leaving the remaining portion of the output display unaffected. In one embodiment, if the user moves the user interface for the application around the output display 106, the privacy screen realigns with the application to ensure coverage, no matter the application's location on the output display 106. Alternatively, the privacy screen may only overlap a portion of a output display 106 using diagonal lines (502 in FIG. 5B). Where the privacy screen only overlays a fixed portion of the output display, the movement of the user interface of the application does not affect coverage. In order to prevent unauthorized onlooker from viewing information, the user has the responsibility to move the application with sensitive information into the portion of the output display with the privacy screen.

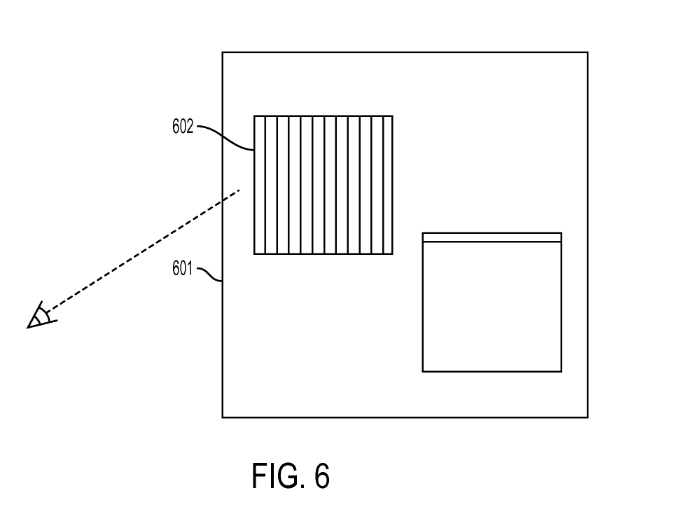

FIG. 6 illustrates the implementation of a software privacy screen over an application interface in accordance with an embodiment of the disclosed subject matter. Specifically, FIG. 6 illustrates the appearance of the output display 106 from the perspective of an unauthorized onlooker at angle and a distance from the output display 106. As shown in FIG. 6, at a distance and from an angle, the privacy screen over the application window (602 in FIG. 6) completely obscures the content of the application window. In practice, adjusting the width, spacing, color, and transparency of the privacy screen can make the screen more or less opaque to the unauthorized onlooker while remaining readable to the user.

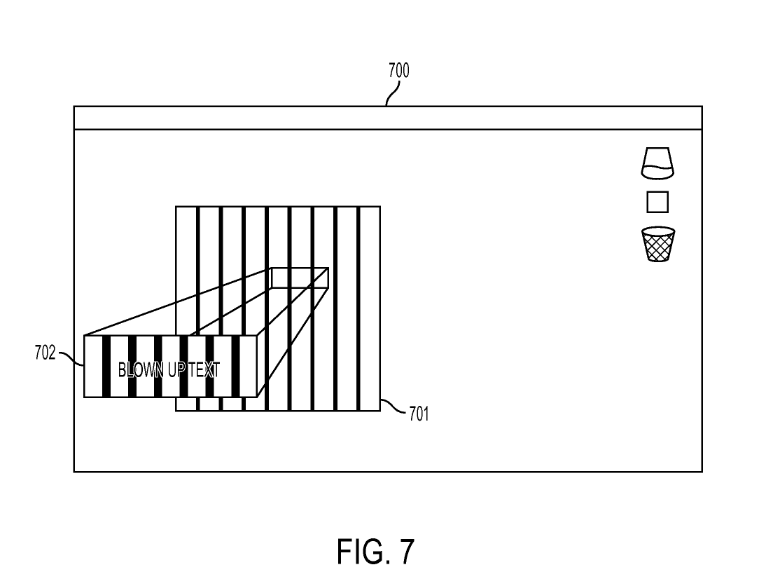

FIG. 7 illustrates the implementation of a software privacy screen over a window comprising a user interface for an application associated with the file or content on an output display (700 in FIG. 7) in accordance with an embodiment of the disclosed subject matter. As described above, the privacy logic 208 and display logic 213 can be configured to display privacy lines across a window comprising a user interface for an application 701. As shown in 702, the privacy lines may be partially transparent in order to allow a user to read the text below them. In contrast, the text is unreadable to a unauthorized onlooker looking at 700 from a distance and/or from an angle to the screen.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method comprising:
receiving a request to open a file or content on a computing device;
in response to the request, generating and displaying a window comprising the file or content in an associated application on an output display associated with the computing device;
determining whether a privacy screen should be applied to the window; and
applying the privacy screen in a visual layer over the window if the privacy screen should be applied, wherein the privacy screen is comprised of a plurality of privacy lines configured to allow a user of the computing device to view contents of the window and to prevent an unauthorized onlooker from viewing the contents of the window.

2. The method of claim 1, wherein generating and displaying the window further comprises determining the application associated with the requested file.

3. The method of claim 1, further comprising:
determining whether the privacy screen applies to one of the application and the file;
if the privacy screen applies to the application, applying the privacy screen to the window for the file or content and any other file or content opened in the application; and
if the privacy screen applies to the file or content, applying the privacy screen to the window for the file or content and separately determining whether the privacy screen applies to any other file or content opened in the application.

4. The method of claim 1, wherein determining whether the privacy screen should be applied comprises at least one of:
checking a stored privacy setting indicating whether to apply the privacy screen to the application; and
receiving a request to apply the privacy screen to the application.

5. The method of claim 1, wherein determining whether the privacy screen should be applied comprises:
determining whether the output display is physically located external to a secure office environment; and
applying the privacy screen to the window if the computing device is physically located external to the secure office environment.

6. The method of claim 1, wherein the plurality of privacy lines comprises at least one of a plurality of lines having a predefined orientation, thickness of the lines, spacing between the lines, distance to the window, color, and transparency.

7. The method of claim 1, wherein the plurality of privacy lines is user-configurable.

8. A non-transitory computer readable medium having executable instructions that are operable to cause a data processing apparatus to:
receive a request to open a file or content on a computing device;
in response to the request, generate and display a window comprising the file or content in an associated application on an output display associated with the computing device;
determine whether a privacy screen should be applied to the window; and
apply the privacy screen in a visual layer over the window if the privacy screen should be applied, wherein the privacy screen is comprised of a plurality of privacy lines configured to allow a user of the computing device to view contents of the window and to prevent an unauthorized onlooker from viewing the contents of the window.

9. The computer readable medium of claim 8, further comprising executable instructions operable to cause the data processing apparatus to determine the application associated with the requested file.

10. The computer readable medium of claim 8, further comprising executable instructions operable to cause the data processing apparatus to:
determine whether the privacy screen applies to one of the application and the file;
if the privacy screen applies to the application, apply the privacy screen to the window for the file or content and any other file or content opened in the application; and
if the privacy screen applies to the file, apply the privacy screen to the window for the file or content and separately determine whether the privacy screen applies to any other file or content opened in the application.

11. The computer readable medium of claim 8, further comprising executable instructions operable to cause the data processing apparatus to at least one of:
check a stored privacy setting indicating whether to apply the privacy screen to the application; and
receive a request to apply the privacy screen to the application.

12. The computer readable medium of claim 8, further comprising executable instructions operable to cause the data processing apparatus to:
determine whether the output display is physically located external to a secure office environment; and
apply the privacy screen to the window if the computing device is physically located external to the secure office environment.

13. The computer readable medium of claim 8, wherein the plurality of privacy lines comprises at least one of a plurality of lines having a predefined orientation, thickness of the lines, spacing between the lines, distance to the window, color, and transparency.

14. The computer readable medium of claim 8, wherein the plurality of privacy lines is user-configurable.

15. An apparatus comprising:
a processor configured to run a module stored in memory, the module configured to:
receive a request to open a file or content on a computing device;
in response to the request, generate and display a window comprising the file or content in an associated application on an output display associated with the computing device;
determine whether a privacy screen should be applied to the window; and
apply the privacy screen in a visual layer over the window if the privacy screen should be applied, wherein the privacy screen is comprised of a plurality of privacy lines configured to allow a user of the computing device to view contents of the window and to prevent an unauthorized onlooker from viewing the contents of the window.

16. The apparatus of claim 15, wherein the module configured to generate and display the window is further configured to determine the application associated with the requested file.

17. The apparatus of claim 15, wherein the module is further configured to:
determine whether the privacy screen applies to one of the application and the file;
if the privacy screen applies to the application, apply the privacy screen to the window for the file or content and any other file or content opened in the application; and
if the privacy screen applies to the file, apply the privacy screen to the window for the file or content and separately determine whether the privacy screen applies to any other file or content opened in the application.

18. The apparatus of claim 15, wherein the module is further configured to at least one of:
check a stored privacy setting indicating whether to apply the privacy screen to the application; and
receive a request to apply the privacy screen to the application.

19. The apparatus of claim 15, wherein the module configured to determine whether the privacy screen should be applied is further configured to:
determine whether the output display is physically located external to a secure office environment; and
apply the privacy screen to the window if the computing device is physically located external to the secure office environment.

20. The apparatus of claim 15, wherein the plurality of privacy lines comprises at least one of a plurality of lines having a predefined orientation, thickness of the lines, spacing between the lines, distance to the window, color, and transparency.
